(19) United States
(12) Patent Application Publication
(10) Pub. No.: US 2019/0024453 A1
(43) Pub. Date: Jan. 24, 2019

(54) UNIVERSAL AUTOMATIC TENSIONING SYSTEM FOR ROLLER BLINDS AND AWNINGS WITH SIDE RAILS

(71) Applicant: Rollease Acmeda Inc, Stamford, CT (US)

(72) Inventor: Marco Raggini, Coriano (RN) (IT)

(21) Appl. No.: 16/062,529

(22) PCT Filed: Dec. 16, 2016
(86) PCT No.: PCT/EP2016/081360

§ 371 Date: Jun. 14, 2018

(30) Foreign Application Priority Data
Dec. 20, 2015 (EP) 15201446.0

(51) Int. Cl. E06B 9/88

(52) U.S. Cl. CPC E06B 9/88; E06B 2009/805

(57) ABSTRACT

An universal automatic tensioning system, for roller blinds and awnings with side rails, comprising a crossbar (2) equipped with a spring pin (6) that can move along a side guide (3) that defines the rail for the shift of the awning (1), characterized in that it includes one or more fixed clip(s) (4) that can be hooked by the spring pin (6) causing the locking of the roller blind (1); a further movement of the awning's crossbar (2) will force the spring pin (6) engaging with a mobile flap (5) that works as a sort of “bridge” for the spring pin (6), causing the unlocking of the crossbar (2), so as to realize the setting for the automatic tensioning of the roller blind (1).

### TECHNICAL FIELD

This invention relates to a device for automatic locking and tensioning several type of roller blinds with lateral guides or cables, including “Shy Zip” system, vertical drop-down, roll-up and sloped “in traction” awnings.

### BACKGROUND ART

Today is growing the variety of awnings and roller blinds with side rails, from the vertical “free falling” type to the horizontal or sloped “in traction” ones, constrained by cables or belts. Most of these solutions need a tension of the fabric in some positions (intermediate or at the point of max length) in order to maximize their performance against the wind, for the better drainage of the rain and also for the user's safety. This tension of the fabric in some cases may be reached with a manual lock system, but in a lot of other cases (eg. when the roller blind is external to a window, is located in not simply accessible positions or is commanded by a wind sensor) it is required an automatic tensioning system.

Some producers have already invented devices to achieve these goals, but only for few specific applications, often that work only with own products. Main drawbacks of already existing assembly are: the non-universality of application, the impossibility of working simultaneously in two or more points along the side rail, the not easy adjustability of the position of devices in case of installations with irregular measures and dilatations of the fabric, the applications with “Shy Zip” rails are limited and incomplete, it's very difficult to exit from a “infinite loop problem” if the locking system fails for some motivations (eg. raising of the awning during a windstorm).

### DISCLOSURE OF INVENTION

The present invention has the aim to solve the above written drawbacks, merging in a single appliance the solution to many problems of users.

Within this aim, a goal of the invention is to develop a device that ensures the lock of the awning at an intermediate or fully extended point and subsequently tensioning it moving the awning with a manual winch or through an electric motor. The unlock of the roller blind will be performed simply by a brief “opposite direction” movement of the roller, followed by the movement in the correct direction.

Another goal of the invention is to devise an assembly that is simply adaptable to different situations and awning models (various manufacturers), it may be invisible, inserted into side rails or external (covered by a box) in case of awning with steel cable guides.

A further object of the invention is to develop a device that ensures an high level of reliability in its functioning and that allows easy position adjustments after possible deterioration of the fabric in the course of time.

A further goal of the invention is to develop a device that can be realized at low costs, with materials that are simply findable in the market.

A further object of the invention is to develop an assembly that may be used on roller blinds which are vertical or sloped at every angle, that are moving in any direction, endowed or not of the “Shy Zip” system.

A further goal of the invention is to develop a device that ensures a solution in case of “out of phase” and of the consequently “infinite loop” problem, peculiar drawback of many existing locking systems.

This aim and these objects are achieved by a universal automatic tensioning system for outdoor and indoor awnings, roller blinds and mosquito screens, having at least one crossbar that can move along a guide or a steel cable. The assembly is made of two different parts: one “static” device settled up on both side rails and one “dynamic” device placed at the ends of the crossbar of the awning. The static device comprises a fixed clip at the top and a mobile flap positioned below it, the static device can be moved in different positions along the side rails, depending on necessity. The dynamic device is made up of a “spring pin” (cylindrical or different shaped), that is kept elastically in contrast with the static device by a spring. The downward movement of the roller blind causing the dynamic device engaging the static one, firstly in the fixed clip, to lock and tension the fabric (or panel), secondly engaging the mobile flap to unlock the awning, continuing the climb. In case of partial lock of the awning, the invention permit a smart and fast “reset” method, avoiding the problem of “infinite hook-release loop”.

### BRIEF DESCRIPTION OF DRAWINGS

These and other characteristics will now be made more evident through the description of some embodiment of the invention, given merely for illustrative purposes without restricting the scope of this patent. With reference to the attached drawings, wherein:

FIG. 1 is a perspective front view of the tensioning system, installed on a “sample awning” (with an aluminum guide on left side and a steel cable on the right side).

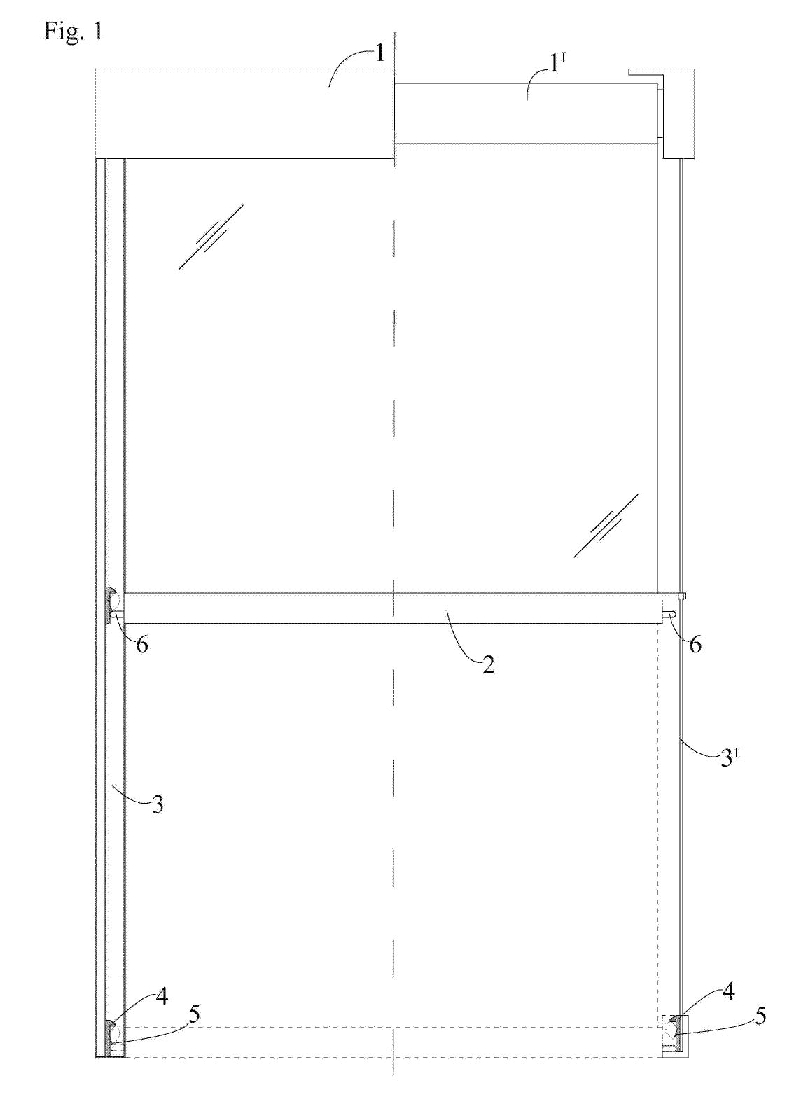

FIG. 2 is a sectional view of the “static part” of the tensioning system.

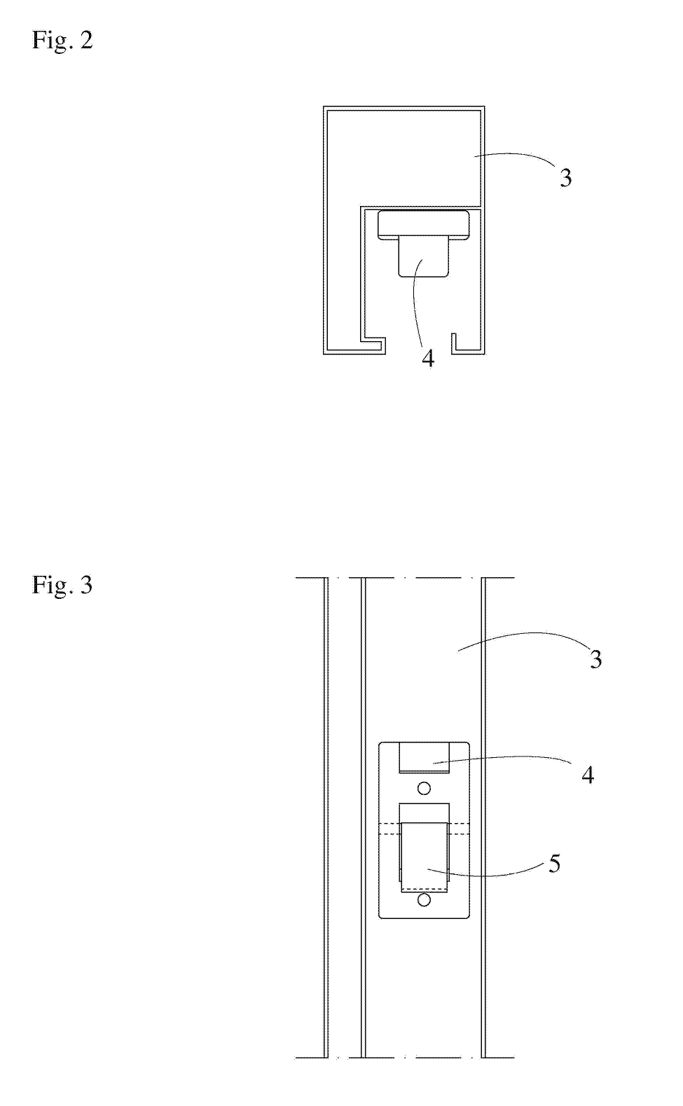

FIG. 3 is a front view of the “static part” of the tensioning system.

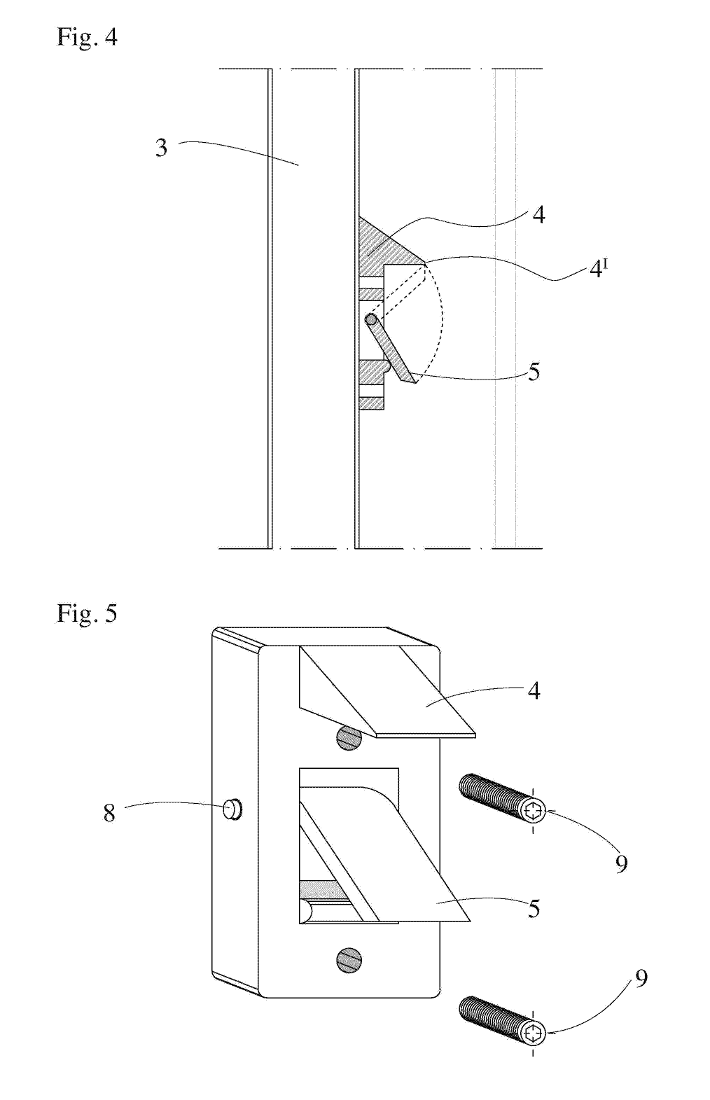

FIG. 4 is a side elevation view of the “static part” of the tensioning system.

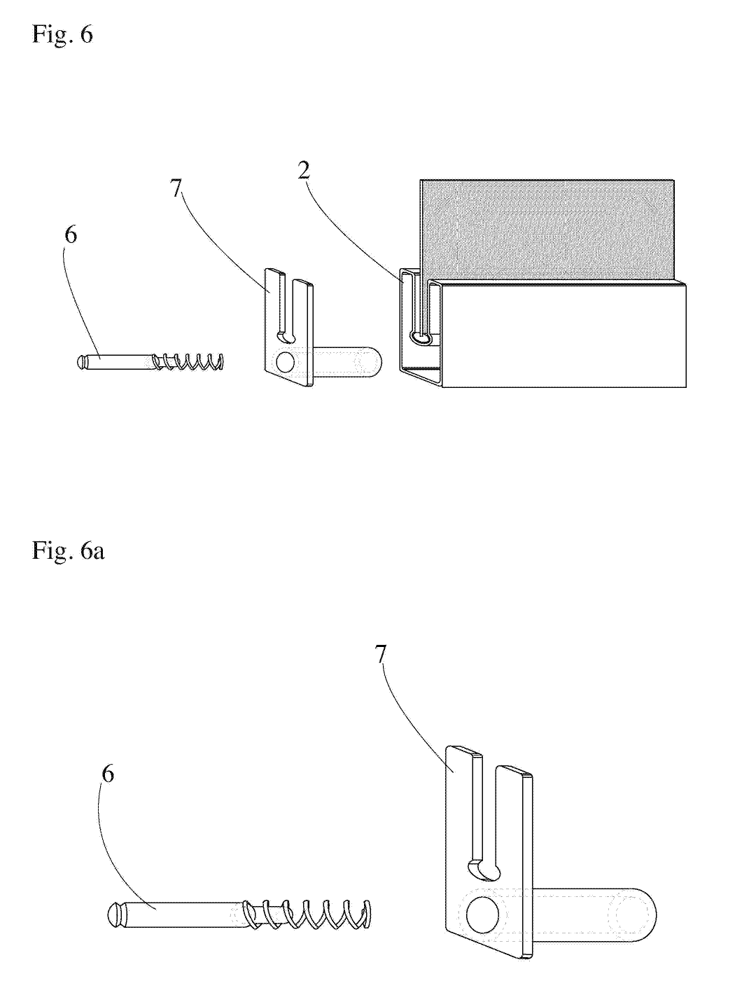

FIG. 5 is an exploded perspective front view of the “static part” of the tensioning system.

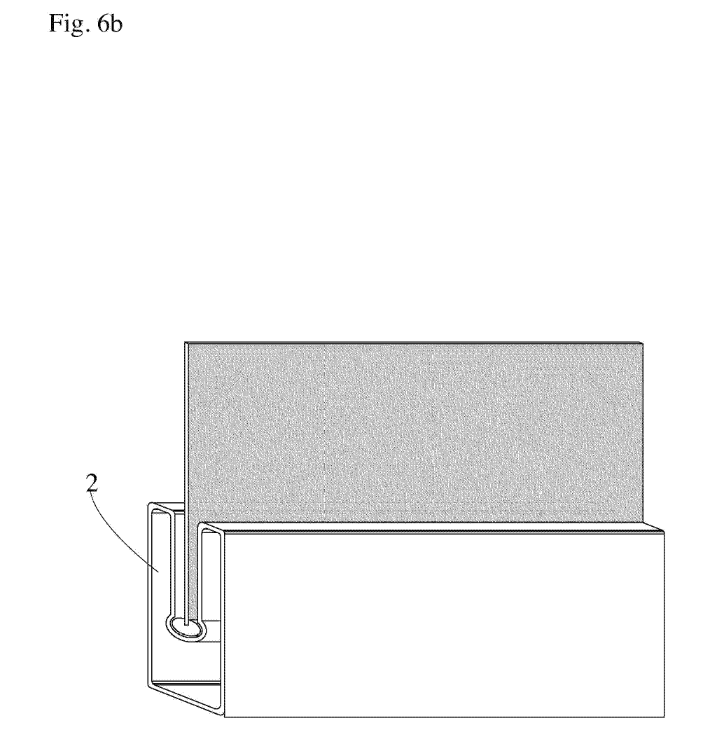

FIG. 6 is an exploded perspective front view of the “dynamic part” of the tensioning system.

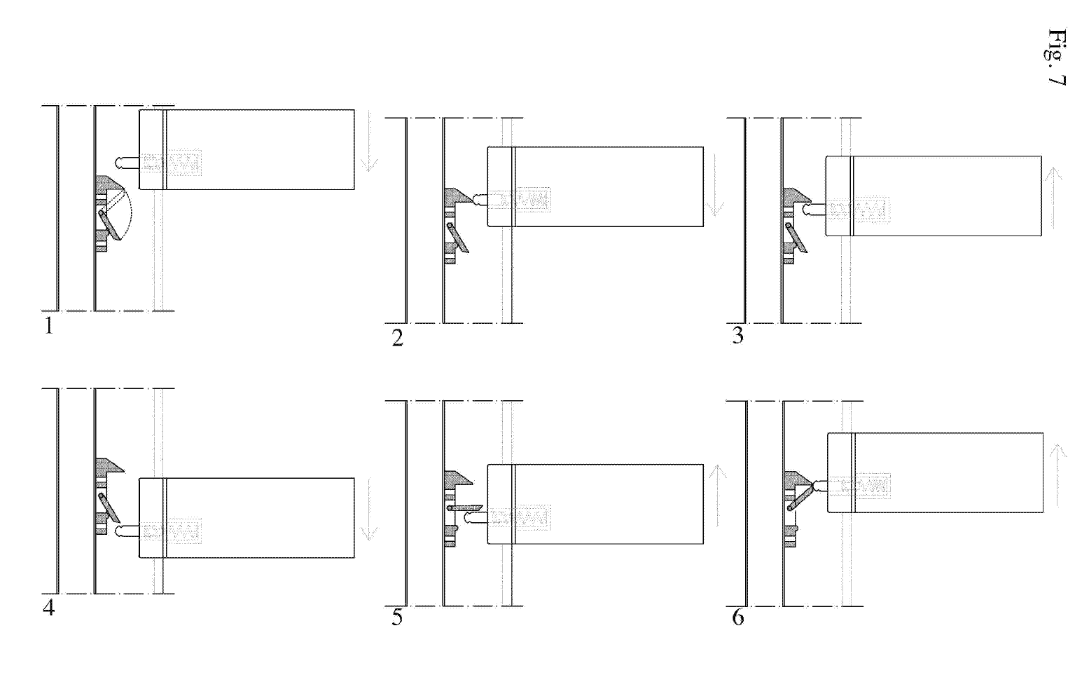

FIG. 6a/6b represents further details of FIG. 6.

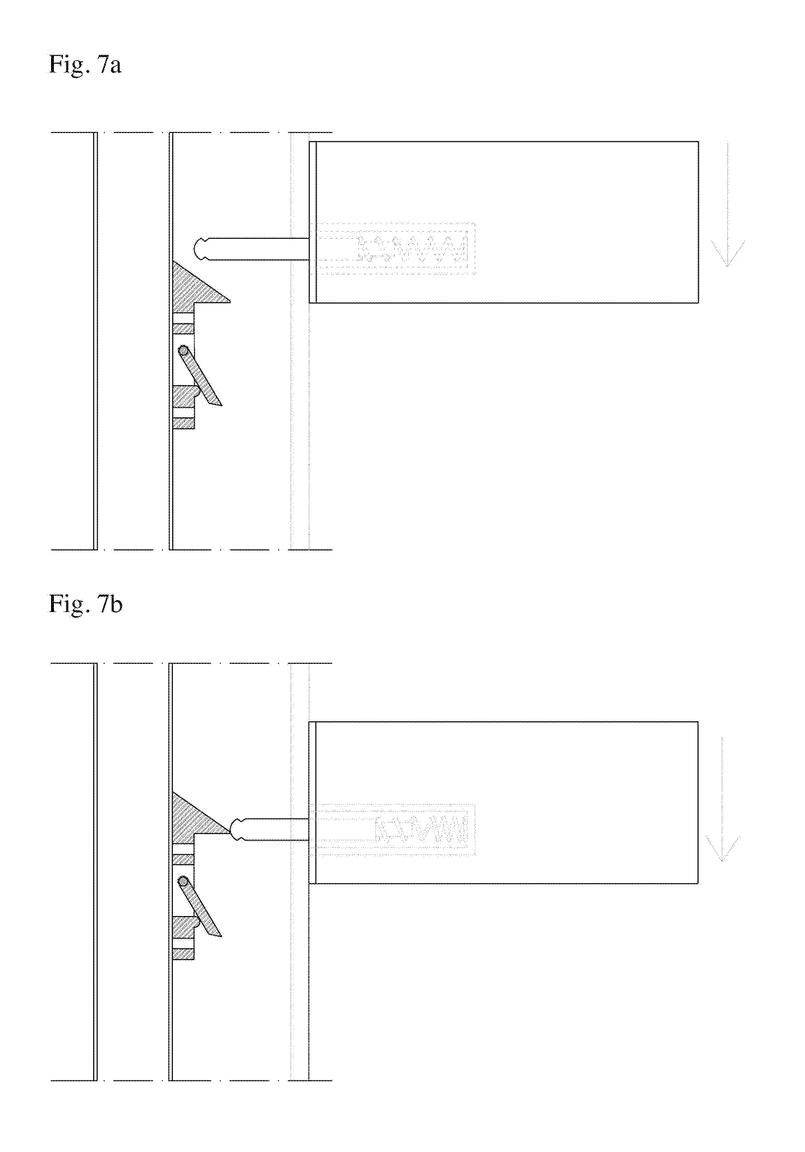

FIG. 7 shows some side elevation views of the whole tensioning system, as phases of the working mechanism; it highlights the interaction between the “static” and the “dynamic” devices in order to work correctly.

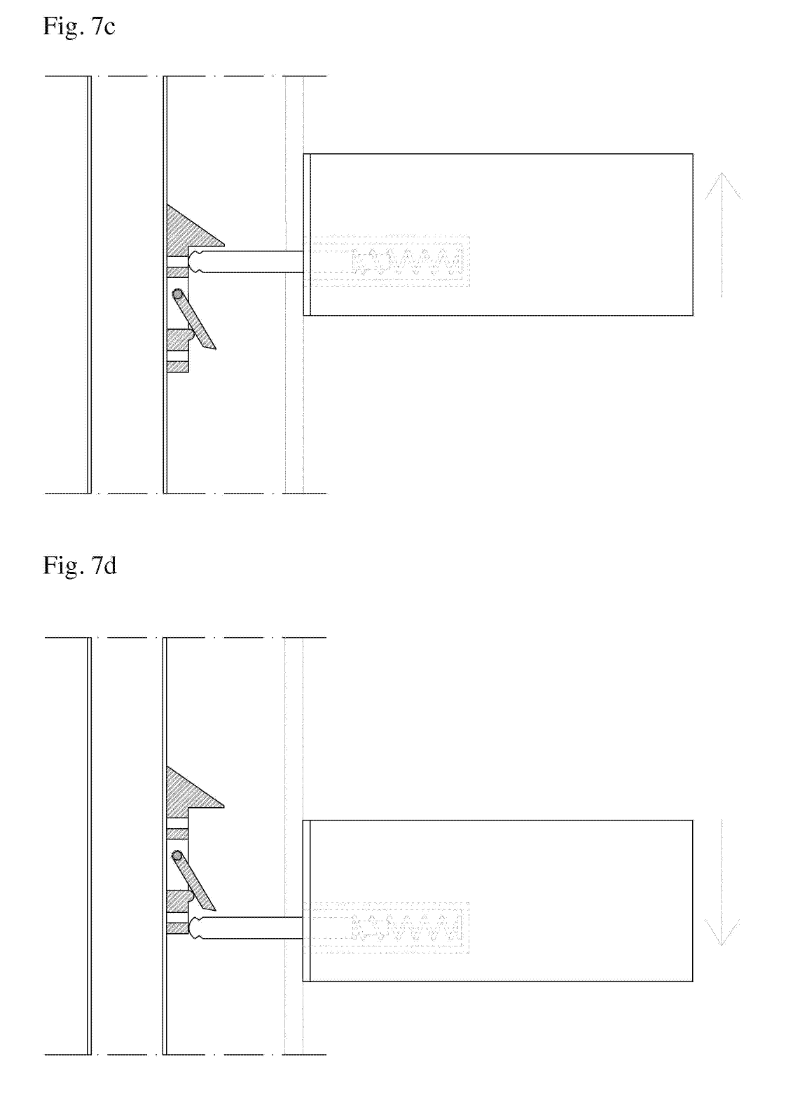

FIG. 7a-7f represents further details of FIG. 7, showing better single phases of the tensioning system functioning.

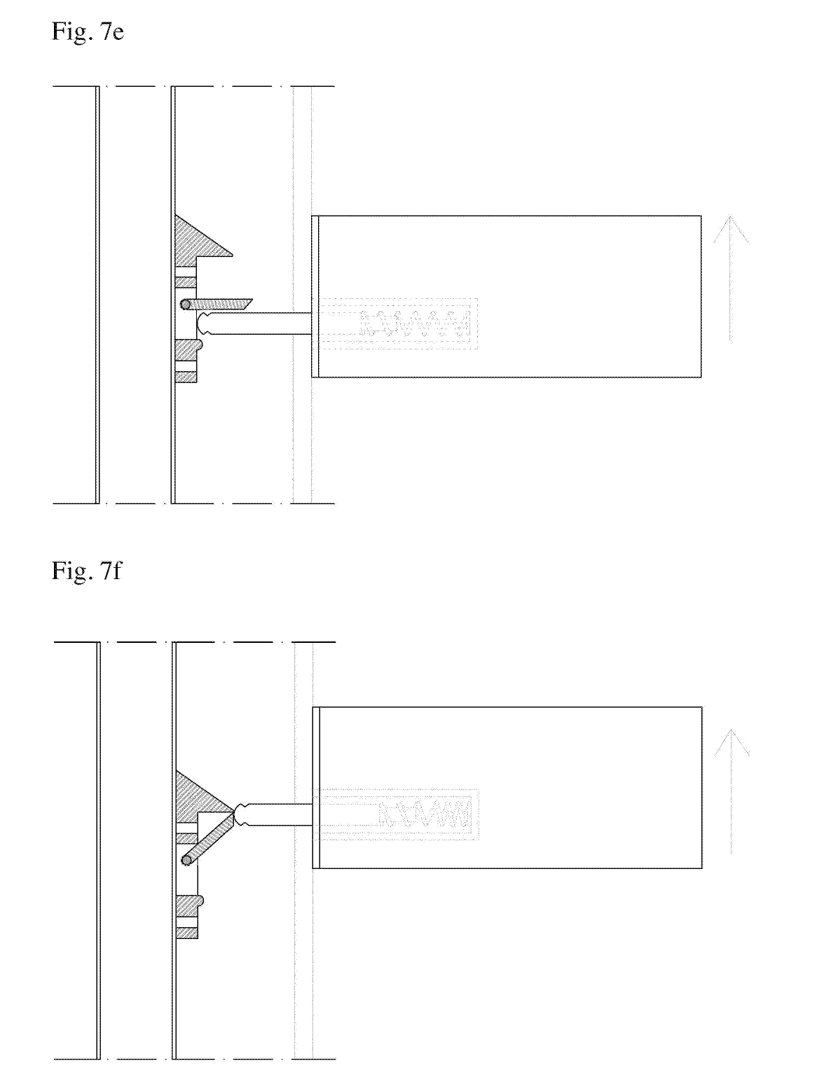

### BEST MODE FOR CARRYING OUT THE INVENTION

With reference to said figures, 1 indicates an awning or roller blind, having at least one crossbar, one roller and operation mechanisms (with or without a cover box), 2 the crossbar at the bottom side of the fabric, 3 the side rails (extruded aluminum guides or steel cables), 4 the fixed clip, 5 the mobile flap, 6 the spring pin, 7 the stopper of the crossbar, 8 a metal pin that allows the union between the fixed clip (4) and the mobile flap (5), 9 the metal screws that permit the securing and the shifts of the whole static part of the tensioning system along side rails (3).

The device works as follows: during the scrolling, in any position, the spring pin (6) flows along the side rails (3) and it comes up against the fixed clip (4); after it has exceeded completely the protrusion (4^{I}) the extension phase is ended and the reversion starts, so the spring pin (6) will be forced to stand still, allowing the tensioning of the fabric.

When the roller blind (1) is to be moved from lock position, firstly is scrolled enough to permit to the spring pin (6) the complete overtake of the mobile flap (5), secondly the awning (1) is scrolled in the opposite direction (manually or automatically with a motor) and now the spring pin (6) engages the mobile flap (5), that swings toward the protrusion (4^{I}) of the fixed clip (4), allowing to the crossbar (2) the bypassing of the lock position and the return to free moving.

It should be made clear that the use on roller blinds and awnings is a peculiar but not exclusive application of the automatic tensioning system according to the invention; is not excluded the possibility of using the tensioning system on different types of awning, blind, window, door and other similar.

In practice the construction details, shape, materials, dimensions and other aspects of the invention may change without derogate from the goal of this industrial patent.

Finally, all the elements can be replaced with other technically equal ones.

1. Universal automatic tensioning system, for roller blinds and awnings with side rails comprising:
a crossbar (2) equipped with a spring pin (6) that can move along a side guide (3) that defines the rail for the shift of the awning (1),
characterized in that it includes one or more fixed clip(s) (4) that can be hooked by the spring pin (6) causing the locking of the roller blind (1); a further movement of the awning's crossbar (2) will force the spring pin (6) engaging with a mobile flap (5) that works as a sort of “bridge” for the spring pin (6), causing the unlocking of the crossbar (2), so as to realize the setting for the automatic tensioning of the roller blind (1).

2. Universal automatic tensioning system, for roller blinds and awnings with side rails according to claim 1, characterized in that in includes two of said spring pins (6), which are set on opposite sides of the awning's crossbar (2) and two (or multiple) fixed clips (4) with their corresponding mobile flaps (5) in order to determine a balanced tensioning of the awning (1).

3. Universal automatic tensioning system, for roller blinds and awnings with side rails according to the claim 2, characterized in that the fixed clip (4) and the mobile flap (5) are joined together forming a so-called “static part” that can be secured in a position near the end limit of the side rails (3) and/or in many other intermediate positions, in order to ensure the automatic tensioning of the roller blind (1) in different points.

4. Universal automatic tensioning system, for roller blinds and awnings with side rails according to the claim 3, characterized in that said static part can be shifted up or down along side rails (3) and placed in different position in the two sides, in order to ensure a correct functioning of the tensioning system also in case of installations with irregular measures.

5. Universal automatic tensioning system, for roller blinds and awnings with side rails according to claim 4, characterized in that said static part can be inserted (hidden) into metallic side guides (3) or put out (naked or clothed by a cover) on side rail, especially in case of steel cables (3^{I}), obtaining the same performance.

6. Universal automatic tensioning system, for roller blinds and awnings with side rails according to claim 1, characterized in that awning controls may be manual, with operation by means of a hand winch, or motorized and operated by means of a remote control and moreover, in this latter case, commands can be also given automatically from devices sensitive to the wind force, the brightness of light or the rain.

7. Universal automatic tensioning system, for roller blinds and awnings with side rails according to claim 1, characterized in that the invention is described as an accessory for drop-down awnings and roller blinds (1) can also be applied, obtaining the same performance, for “roll-up” awnings and horizontal or sloped roller blinds.

8. Universal automatic tensioning system, for roller blinds and awnings with side rails according to claim 1, characterized in that the automatic tensioning system, described as an accessory for awnings (1) with “simple” side guides may be also applied, obtaining the same performance, for awnings with “Shy Zip” guides and with rails made of steel cables (3^{I}).

9. Universal automatic tensioning system, for roller blinds and awnings with side rails according to claim 1, characterized in that the invention can be applied as accessory for roller blind (1) with cover box or for awning without a cover box (1^{I}), obtaining the same performance.
